(19) United States
(12) Patent Application Publication
(10) Pub. No.: US 2024/0160492 A1
(43) Pub. Date: May 16, 2024

(54) SYSTEM AND METHOD FOR RADIO ACCESS NETWORK BASEBAND WORKLOAD POOL RESIZING

(71) Applicants: Altiostar Networks India Private Limited, Bangalore (IN); Altiostar Networks, Inc., Tewksbury, MA (US)

(72) Inventors: Ronak Bharatkumar LALWALA, Bangalore (IN); Raghunath HARIHARAN, Tewksbury, MA (US); Mruthyunjaya NAVALI, Tewksbury, MA (US)

(73) Assignees: Altiostar Networks India Private Limited, Bangalore (IN); Altiostar Networks, Inc., Tewksbury, MA (US)

(21) Appl. No.: 18/496,028

(22) Filed: Oct. 27, 2023

(30) Foreign Application Priority Data
Nov. 10, 2022 (IN) 202241064133

(51) Int. Cl. G06F 9/50

(52) U.S. Cl. CPC G06F 9/505

(57) ABSTRACT

An apparatus for resource management in a network environment includes at least one memory storing instructions and at least one processor configured to execute the instructions to allocate at least one first central processing unit (CPU) core to perform tasks corresponding to a first layer of the network environment, allocate at least one second CPU core to perform tasks corresponding to a second layer of the network environment, allocate at least one third CPU core to perform tasks corresponding to the second layer of the network environment, determine at least one network usage parameter corresponding to usage of at least one of the first layer and the second layer, and reallocate at least one of the at least one third CPU core to perform tasks corresponding to the first layer of the network environment based on the at least one network usage parameter.

### CROSS-REFERENCE TO RELATED APPLICATION(S)

This application is based on and claims priority to Indian Patent Application No. 202241064133, filed on Nov. 10, 2022, in the India Patent Office, the disclosure of which is incorporated herein by reference in its entirety.

### BACKGROUND

### 1. Field

Apparatuses and methods consistent with example embodiments of the present disclosure relate to resource allocation in a network environment.

### 2. Description of Related Art

In related art, radio access network (RAN) functions, such as distributed units (DUs), incorporate central processing unit (CPU) intensive baseband (BB) processing. Physical layer (layer 1/L1) and data link/scheduling layer (layer 2/L2) applications may be hosted in the same BB pod with a static CPU core split based on a predefined deployment model. When implementing a static allocation of CPU resources, dimensioning of the RAN may be performed based on expectation rather than actual or real-time network parameters, causing underutilization or inefficient utilization of CPU resources.

### SUMMARY

According to embodiments, systems and methods are provided for resource allocation between layers in a network environment to optimize processing resources during operation.

According to an aspect of the disclosure, an apparatus for resource management in a network environment may include at least one memory storing instructions and at least one processor configured to execute the instructions to allocate at least one first central processing unit (CPU) core to perform tasks corresponding to a first layer of the network environment, allocate at least one second CPU core to perform tasks corresponding to a second layer of the network environment, allocate at least one third CPU core to perform tasks corresponding to the second layer of the network environment, determine at least one network usage parameter corresponding to usage of at least one of the first layer and the second layer, and reallocate at least one of the at least one third CPU core to perform tasks corresponding to the first layer of the network environment based on the at least one network usage parameter.

According to an aspect of the disclosure, a method for resource management in a network environment may include allocating at least one first CPU core to perform tasks corresponding to a first layer of the network environment, allocating at least one second CPU core to perform tasks corresponding to a second layer of the network environment, allocating at least one third CPU core to perform tasks corresponding to the second layer of the network environment, determining at least one network usage parameter corresponding to usage of at least one of the first layer and the second layer, and reallocating at least one of the at least one third CPU core to perform tasks corresponding to the first layer of the network environment based on the at least one network usage parameter.

According to an aspect of the disclosure, a non-transitory computer-readable storage medium may store instructions that, when executed by at least one processor, cause the at least one processor to allocate at least one first CPU core to perform tasks corresponding to a first layer of the network environment, allocate at least one second CPU core to perform tasks corresponding to a second layer of the network environment, allocate at least one third CPU core to perform tasks corresponding to the second layer of the network environment, determine at least one network usage parameter corresponding to usage of at least one of the first layer and the second layer, and reallocate at least one of the at least one third CPU core to perform tasks corresponding to the first layer of the network environment based on the at least one network usage parameter.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram showing central processing unit (CPU) allocation;

FIG. 2 is a diagram showing a pooling framework;

FIGS. 3A and 3B are diagrams showing CPU core allocation, according to an embodiment;

FIGS. 4A and 4B are diagrams showing CPU core allocation, according to an embodiment;

FIG. 5 is a flowchart of a method for resource management, according to an embodiment;

FIG. 6 is a diagram of an example environment in which systems and/or methods, described herein, may be implemented; and

FIG. 7 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system in which central processing unit (CPU) resources may be allocated and optimized. For example, the system may allocate first CPU cores to perform tasks corresponding to a first layer (e.g., layer 1/L1), allocate second CPU cores to perform tasks corresponding to a second layer (e.g., layer 2/L2), and allocate third CPU cores. The third CPU cores may be initially allocated to perform tasks corresponding to the second layer. Depending on operational parameters and network usage, the system may determine that resources allocated to the second layer may be utilized to perform tasks corresponding to the first layer. Thus, the system may determine to reallocate the third CPU cores to perform tasks corresponding to the first layer. Furthermore, when the tasks performed by the third CPU are completed, or when network usage parameters change, the system may then reallocate the third CPU cores to perform tasks corresponding to the second layer. That is, the third CPU cores may correspond to floating cores that have an initial allocation corresponding to a first layer of the network, and then based on network usage parameters, reallocate the floating cores to perform tasks corresponding to the second layer. Thus, non-utilized or underutilized CPU cores may be reallocated to perform tasks for other layers, increasing the effective utilization of CPU cores, optimizing processing efficiency and efficacy of the CPU in the network environment, while improving the “performance per watt” of a distributed unit (DU) (i.e., improving power consumption) while reducing the operation expense of the network.

Radio access network (RAN) processing may be deployed on servers built with multi-core processors utilizing multi-threading capability to parallelize the workload on cores, saving processing time and improving latency. The Hyperthreading technology may enable two logical processors in a single physical processor by replacing, partitioning and sharing the resources of the core. Each of these contexts may be referred to as a logical core, and a software thread may be spawned on each of the logical cores, which the hardware runs in parallel.

In RAN baseband (BB) processing, the system may convert time-domain IQ samples received from radios to bits usable by the media access control (MAC) and vice versa. For over the air radio frequency (RF) communications, the time may be divided into transmission intervals (TTI), all having the same duration. In each TTI, data may be received from radio units, and new data may be prepared to be transmitted to the radio units. Hence, an end-to-end response time may be smaller than a period equal to the TTI duration. If the response data is not ready before the time for the transmission arrives, it may result in response failure.

BB task processing thus has a stricter demand for data transfer and processing latency, and may require real-time scheduling policies for time-critical tasks. BB task pooling frameworks may provide a task dispatching and execution system over a set of CPU resources, such that the workload is automatically balanced across multiple cores. This addresses latency bound processing of software tasks while enabling power saving optimizations. The same mechanisms may be applied to edge could applications, such as computer visions/perception employed in autonomous driving and user interfaces (e.g., augmented reality/virtual reality configurations).

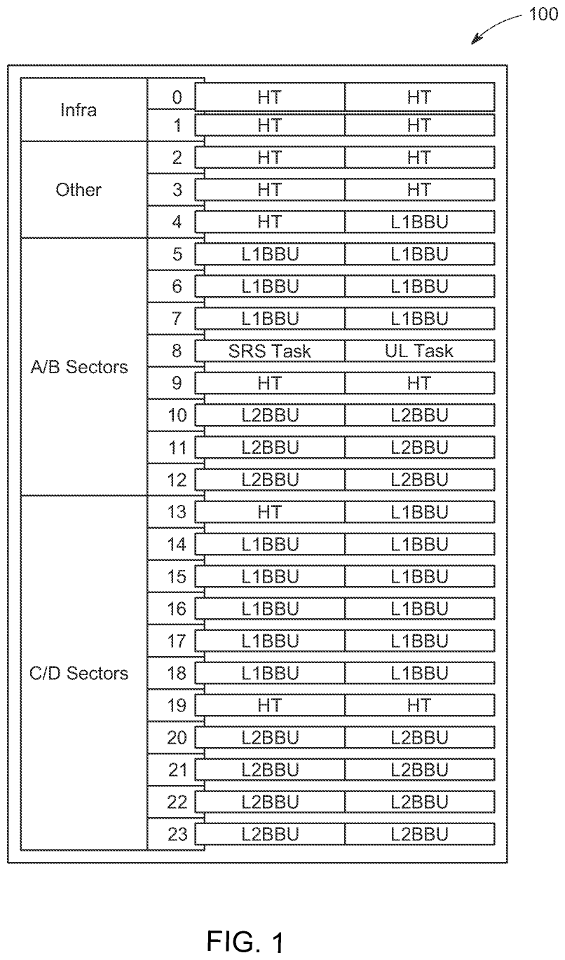

FIG. 1 is a diagram showing CPU allocation. For example, as shown in FIG. 1, the CPU 100 may include 24 physical cores (i.e., cores 0-23), and each core may include at least two hyperthreads (HTs). That is, the CPU core may correspond to a physical processor/physical core, whereas an HT may correspond to a logical processor/logical core. For example, core 4 may include a first HT allocated for miscellaneous purposes, and an L1 baseband (BB) unit (BBU) task assigned to a second HT. Core 8 may include two HTs, each assigned an L1 BBU task, core 11 may include two HTs, each assigned an L2 BBU task, etc. The tasks may include uplink (UL) tasks, downlink (DL) tasks, sounding reference signal (SRS) tasks, etc.

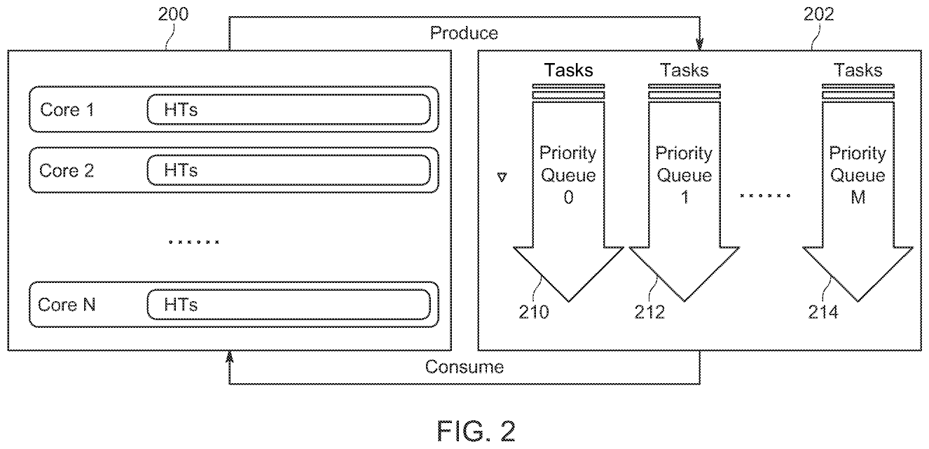

FIG. 2 is a diagram showing a pooling framework. As shown in FIG. 2, a plurality of cores of a CPU 200, such as Core 1, Core 2, . . . Core N, each may include a real-time (RT) thread (e.g., multiple HTs, each running a software task, such as a RT thread), and a task queue 202, including a first task 210 at priority queue 0, a second task 212 at priority queue 1, and a third task 214 at priority queue M may be implemented. The pooling framework may be statically configured with the CPU cores allocated to it. This list of cores may be changed to resize the CPU list allocated to the pool.

Referring to FIGS. 1 and 2, a plurality of tasks may be performed by a CPU or CPUs in a RAN environment. The tasks may correspond to L1 tasks, L2 tasks, etc. The CPU may include cores allocated to perform tasks corresponding to a particular layer. For example, referring to FIG. 1, core 14 may be allocated to perform tasks corresponding to L1, and core 20 may be allocated to perform tasks corresponding to L2. Furthermore, when a task approaches the top of the queue, the task may be assigned to a CPU core based on the layer to which the task corresponds (e.g., L1, L2, L3, etc.).

The allocation of resources for the CPUs may be static and the dimensioning may be performed without reference to network parameters and/or based on a prediction of network usage during operation. However, in actual network operation, the predefined dimensioning may not be effective or efficient, and network usage parameters may not match the processing needs of various states of the network. For example, a task may approach the top of the queue, and the task may correspond to L1. However, if all the cores/HTs allocated to L1 are utilized, the task is not performed/delayed. Thus, various CPU cores may be underutilized or non-utilized, resulting in network operation inefficiency.

According to embodiments, L1 may be configured for processing physical resource blocks (PRBs) for the RAN, and network usage parameters may be determined based on the bandwidth of operations for processing the PRBs. L2 may be configured for processing operations based on a total number of radio resource control (RRC) connected users, as well as an amount of data to be handled corresponding to the number of RRC connected users. Network usage parameters may be determined based on a number of users connected during a predetermined time interval, such as a transmission time interval (TTI) (e.g., 0.5 to 1 millisecond).

The system may configure various thresholds based on network usage parameters. For example, as is described in detail below, the system may configure a processing usage threshold, and based on such a threshold, the system may determine to reallocate cores between layers (parameters and thresholds may be configured at the startup of the BB pod). The system may also configured an RRC user threshold. For example, the system may configured an RRC user threshold corresponding to a number of RRC users connected to the RAN. When the number of RRC users connected to the RAN is low (i.e., below the RRC user threshold), processing requirements for L2 may be reduced, and thus the system may reallocate cores originally allocated to perform tasks corresponding to L2 to perform tasks corresponding to L1. Thus, the available L2 cores may be allocated to perform L1 tasks, increasing the processing availability for performing PRB related tasks.

The number of floating cores which may be reallocated between L2 tasks and L1 tasks may be one or any number of cores. Furthermore, multiple tiers of thresholds may be utilized. For example, the system may configure a first RRC user threshold corresponding to a first number of connected users, and a second RRC user threshold corresponding to a second number of connected users. The second RRC user threshold may be less than the first RRC user threshold. In other words, the number of connected users needed to be below the second RRC user threshold may be less than the number of connected users needed to be below the first RRC user threshold. As an example, the first number of connected users may be 10 and the second number of connected users may be 5. In example embodiments, the system may configure multiple cores to be floating cores. When the number of connected users is below the first RRC user threshold, the system may reallocate a first number of floating cores allocated for L2 tasks to perform L1 tasks. When the number of connected users is below the second RRC user threshold, the system may reallocate the first number of floating cores and an additional second number of floating cores allocated for L2 tasks to perform L1 tasks.

Furthermore, floating cores may be originally allocated for L1 tasks, and may be reallocated to L2 tasks PRB resources, as is described below. The system may configure a first PRB processing threshold corresponding to a first number of PRBs for processing, and a second PRB processing threshold corresponding to a second number of PRBs for processing. The second PRB processing threshold may be less than the first PRB processing threshold.

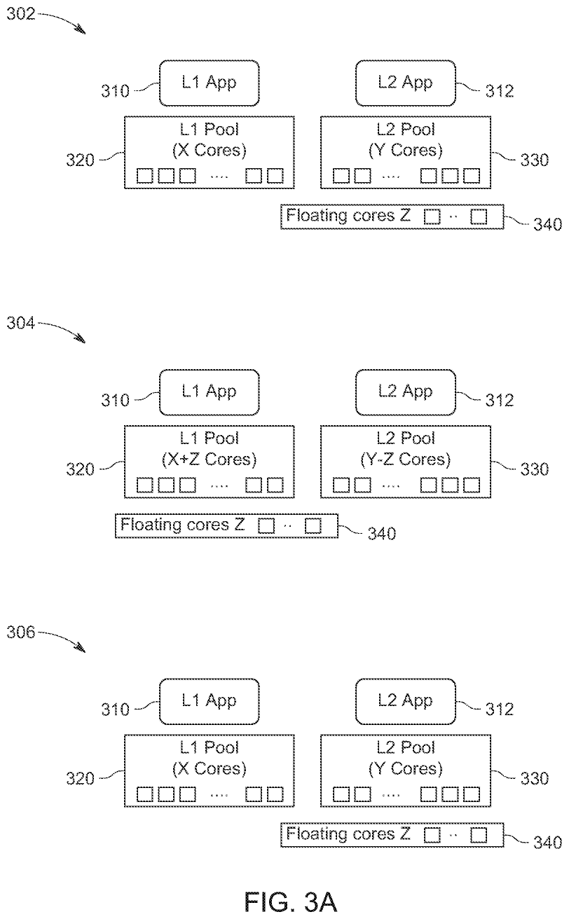

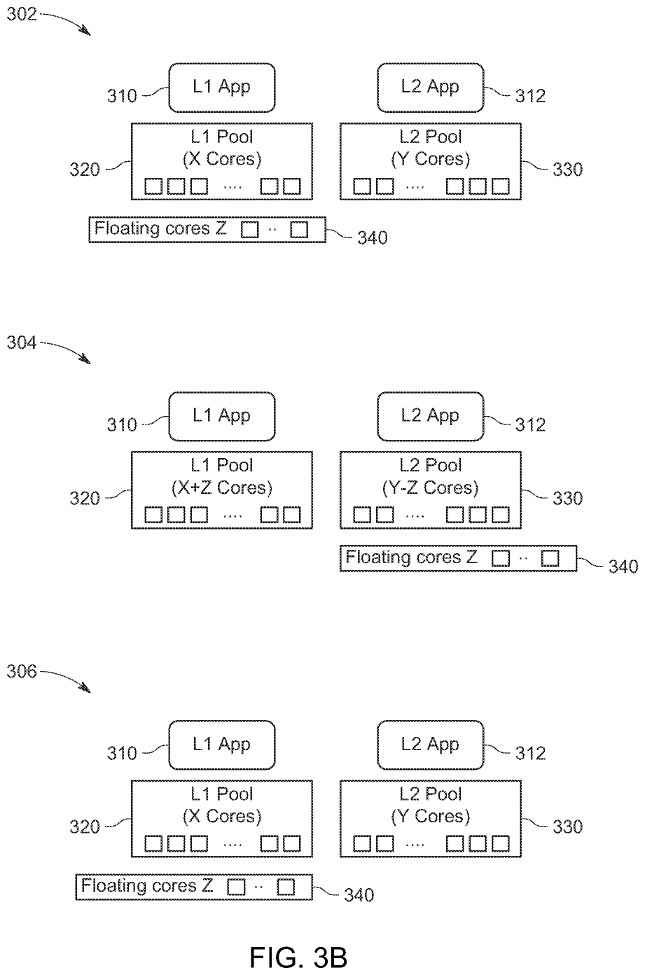

FIGS. 3A and 3B are diagrams showing CPU core allocation, according to an embodiment. Referring to FIG. 3A, as shown in configuration 302, the RAN may be configured to execute an L1 application 310 and an L2 application 312. To process the tasks corresponding to the L1 application 310, the RAN may include a first set of CPU cores 320 (X number of cores) to perform the tasks corresponding to the L1 application 310. To process the tasks corresponding to the L2 application 312, the RAN may include a second set of CPU cores 330 (Y number of cores) to perform the tasks corresponding to the L2 application. As shown in configuration 302, the RAN may include a third set of CPU cores 340 configured as floating cores (Z number of cores, which may be considered to be part of the Y number of cores). As shown in configuration 302, the floating cores 340 may be initialized (e.g., initially allocated) to perform tasks corresponding to L2.

In configuration 304, the system may determine at least one network usage parameter (e.g., data usage, number of connected RRC users, etc.), and based on the at least one network usage parameters, reallocate cores of the floating cores 340 to perform tasks corresponding to the L1 application. Although configuration 304 shows all Z number of cores being reallocated to perform tasks corresponding to L1, the system may be configured to reallocate any number of the floating cores 340 to perform tasks corresponding to L1.

In configuration 306, the system may additionally determine at least one network usage parameter (e.g., data usage, number of connected RRC users, etc.), and based on the determined at least one network usage parameter, reallocate the floating cores 340 to perform tasks corresponding to L2. The system may also determine that the L1 tasks assigned to the floating cores 340 are completed, and may reallocate the floating cores 340 to perform L2 tasks, independent of the determined at least one network parameter. For example, the number of connected RRC users may be below the RRC user threshold, however since the tasks assigned to the floating cores 340 may be completed, the system may reallocate the floating cores 340 back to performing tasks corresponding to L2.

As shown in FIG. 3B, the floating cores 340 may originate in L1 and may be configured to perform tasks corresponding to L1 tasks. Based on the at least one network usage parameter, such as a number of PRBs to be processed, the floating cores 340 may be transitioned from L1 to perform L2 tasks. For example, when a number of PRBs to be processed is less than a PRB processing threshold, the system may determine that all the floating cores 340 are not currently needed for L1 processing, and then may reallocate the floating cores 340 for L2 processing, as is described above with respect to FIG. 3A.

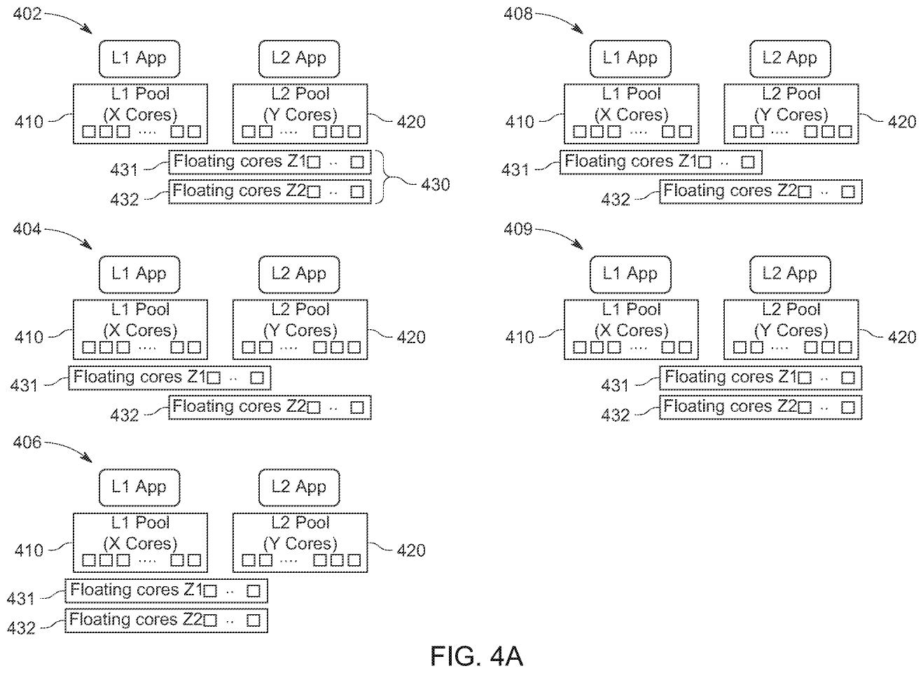

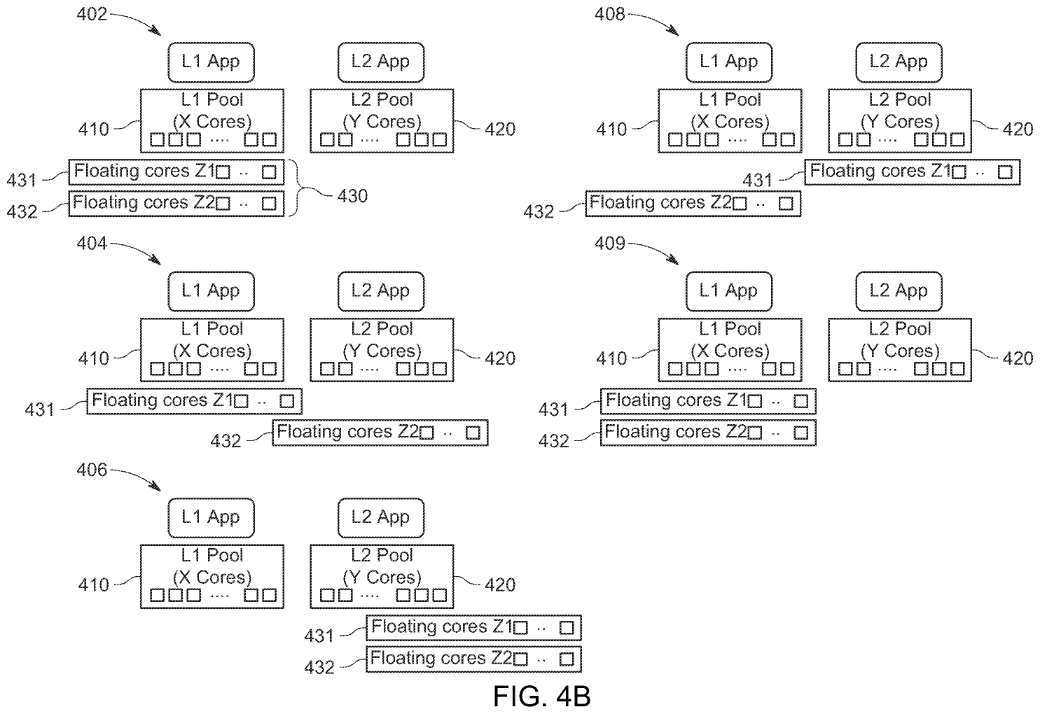

FIGS. 4A and 4B are diagrams showing CPU core allocation, according to an embodiment. The configurations shown in FIGS. 4A and 4B are similar to those of FIGS. 3A and 3B, and repeated description of similar elements will be omitted. Referring to FIG. 4A, the RAN may include first cores 410 (X number of cores) allocated to perform L1 tasks, second cores 420 (Y number of cores) allocated to perform L2 tasks, and a set of floating cores 430 (Z number of cores), including a first set of floating cores 431 (Z1 number of cores) and a second set of floating cores 432 (Z2 number of cores). In configuration 402, the set of floating cores 430 are allocated to perform L2 tasks. In configuration 404, the system may determine at least one network usage parameter, and based on the at least one network parameter being less than a first parameter threshold, the system may allocate the first set of floating cores 431 to perform L1 tasks. For example, the system may determine a number of connected RRC users in the RAN, and based on the number of connected RRC users being less than a first RRC user threshold, the system may reallocate the first set of floating cores 431 to perform L1 tasks.

In configuration 406, the system may again determine at least one network usage parameter, and based on the at least one network parameter being less than a second parameter threshold, the system may reallocate the second set of floating cores 432 to perform L1 tasks, along with the first set of floating cores 431 previously reallocated to perform L1 tasks. For example, the system may determine a number of connected RRC users in the RAN, and based on the number of connected RRC users being less than a second RRC user threshold, the second RRC user threshold being less than the first RRC user threshold, the system may reallocate the second set of floating cores 432 to perform L1 tasks.

In configuration 408, the system may again determine at least one network usage parameter, and based on the at least one network parameter being greater than the second parameter threshold, the system may reallocate the second set of floating cores 432 to perform L2 tasks. For example, the system may determine a number of connected RRC users in the RAN, and based on the number of connected RRC users being greater than the second RRC user threshold and less than the first RRC user threshold, the system may reallocate the second set of floating cores 432 to perform L2 tasks.

In configuration 409, the system may again determine at least one network usage parameter, and based on the at least one network parameter being greater than the first parameter threshold, the system may reallocate the first set of floating cores 431 to perform L2 tasks. For example, the system may determine a number of connected RRC users in the RAN, and based on the number of connected RRC users being greater than the first RRC user threshold, the system may reallocate the first set of floating cores 431 to perform L2 tasks.

As shown in FIG. 4B, the floating cores 431 and 432 may originate in L1 and may be configured to perform tasks corresponding to L1 tasks. Based on the at least one network usage parameter, such as a number of PRBs to be processed, the floating cores 431 and 432 may be transitioned from L1 to perform L2 tasks. For example, when a number of PRBs to be processed is less than a first PRB processing threshold, the system may determine that the floating cores 431 are not currently needed for L1 processing, and then may reallocate the floating cores 431 for L2 processing, as is described above with respect to FIG. 4A. When a number of PRBs to be processed is less than a second PRB processing threshold, the system may determine that floating cores 432 are not currently needed for L1 processing, and then may reallocate the floating cores 432 for L2 processing. When the number of PRBs to be processed is then greater than the second PRB processing threshold but less than the first PRB processing threshold, the system may determine that floating cores 432 are needed for L1 processing, and then may reallocate the floating cores 432 for L1 processing. When the number of PRBs to be processes is then greater than the first PRB processing threshold, the system may determine that floating cores 431 are needed for L1 processing, and then may reallocate the floating cores 431 for L1 processing.

Reference to values being greater than, less than, equal to, etc., is exemplary and not exclusive, as various value comparisons and thresholds may be implemented to determine reallocation of cores without departing from the scope of the disclosure.

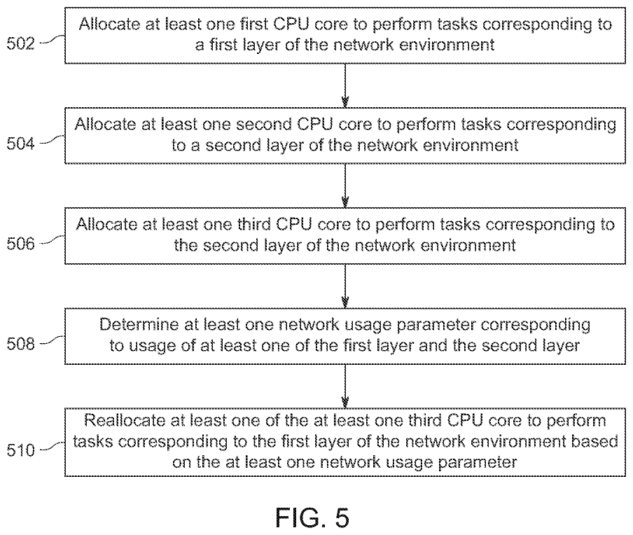

FIG. 5 is a flowchart of a method for resource management, according to an embodiment. In operation 502, the system may allocate at least one first CPU core to perform tasks corresponding to a first layer of the network environment. In operation 504, the system may allocate at least one second CPU core to perform tasks corresponding to a second layer of the network environment. In operation 506, the system may allocate at least one third CPU core to perform tasks corresponding to the second layer of the network environment. In operation 508, the system may determine at least one network usage parameter corresponding to usage of at least one of the first layer and the second layer. In operation 510, the system may reallocate at least one of the at least one third CPU core to perform tasks corresponding to the first layer of the network environment based on the at least one network usage parameter.

By determining network parameters during network operation and reallocating floating cores according to network parameters, the system may provide dynamic adjustment for processing tasks over a static configuration, maximizing CPU usage and availability, improving task performance efficiency and efficacy, while reducing power consumption and operation costs.

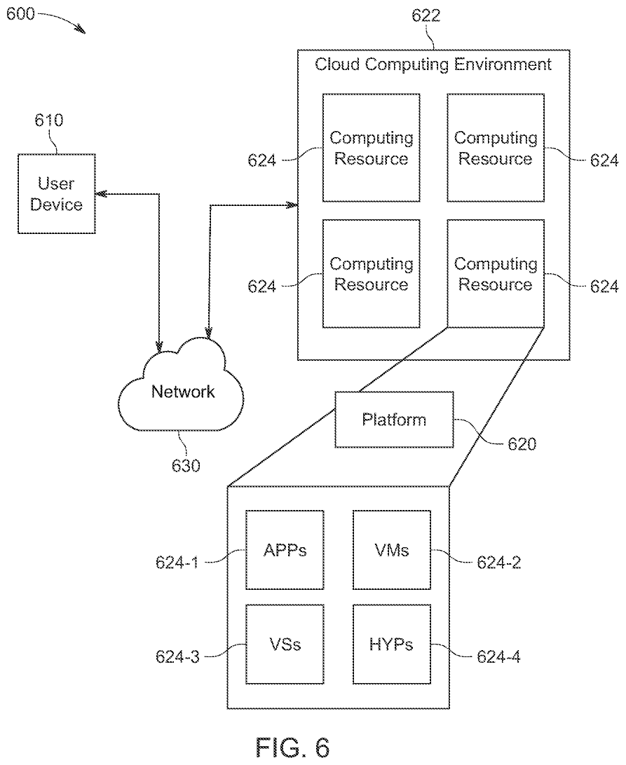

FIG. 6 is a diagram of an example environment 600 in which systems and/or methods, described herein, may be implemented. As shown in FIG. 6, environment 600 may include a user device 610, a platform 620, and a network 630. Devices of environment 600 may interconnect via wired connections, wireless connections, or a combination of wired and wireless connections. In embodiments, any of the functions and operations described with reference to FIG. 1 above may be performed by any combination of elements illustrated in FIG. 6.

User device 610 includes one or more devices capable of receiving, generating, storing, processing, and/or providing information associated with platform 620. For example, user device 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 610 may receive information from and/or transmit information to platform 620.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc. services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like.

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 includes one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

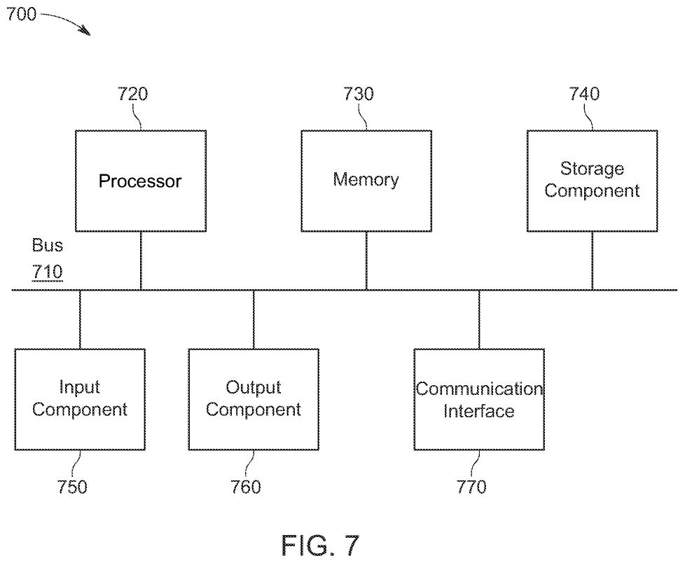

FIG. 7 is a diagram of example components of a device 700. Device 700 may correspond to user device 610 and/or platform 620. As shown in FIG. 7, device 700 may include a bus 710, a processor 720, a memory 730, a storage component 740, an input component 750, an output component 760, and a communication interface 770.

Bus 710 includes a component that permits communication among the components of device 700. Processor 720 may be implemented in hardware, firmware, or a combination of hardware and software. Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 includes one or more processors capable of being programmed to perform a function. Memory 730 includes a random access memory (RAM), a read only memory (ROM), and/or another type of dynamic or static storage device (e.g., a flash memory, a magnetic memory, and/or an optical memory) that stores information and/or instructions for use by processor 720.

Storage component 740 stores information and/or software related to the operation and use of device 700. For example, storage component 740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 750 includes a component that permits device 700 to receive information, such as via user input (e.g., a touch screen display, a keyboard, a keypad, a mouse, a button, a switch, and/or a microphone). Additionally, or alternatively, input component 750 may include a sensor for sensing information (e.g., a global positioning system (GPS) component, an accelerometer, a gyroscope, and/or an actuator). Output component 760 includes a component that provides output information from device 700 (e.g., a display, a speaker, and/or one or more light-emitting diodes (LEDs)).

Communication interface 770 includes a transceiver-like component (e.g., a transceiver and/or a separate receiver and transmitter) that enables device 700 to communicate with other devices, such as via a wired connection, a wireless connection, or a combination of wired and wireless connections. Communication interface 770 may permit device 700 to receive information from another device and/or provide information to another device. For example, communication interface 770 may include an Ethernet interface, an optical interface, a coaxial interface, an infrared interface, a radio frequency (RF) interface, a universal serial bus (USB) interface, a Wi-Fi interface, a cellular network interface, or the like.

Device 700 may perform one or more processes described herein. Device 700 may perform these processes in response to processor 720 executing software instructions stored by a non-transitory computer-readable medium, such as memory 730 and/or storage component 740. A computer-readable medium is defined herein as a non-transitory memory device. A memory device includes memory space within a single physical storage device or memory space spread across multiple physical storage devices.

Software instructions may be read into memory 730 and/or storage component 740 from another computer-readable medium or from another device via communication interface 770. When executed, software instructions stored in memory 730 and/or storage component 740 may cause processor 720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

In embodiments, any one of the operations or processes of FIGS. 1-5 may be implemented by or using any one of the elements illustrated in FIGS. 6 and 7.

According to embodiments, an apparatus for resource management in a network environment may include at least one memory storing instructions and at least one processor configured to execute the instructions to allocate at least one first CPU core to perform tasks corresponding to a first layer of the network environment, allocate at least one second CPU core to perform tasks corresponding to a second layer of the network environment, allocate at least one third CPU core to perform tasks corresponding to the second layer of the network environment, determine at least one network usage parameter corresponding to usage of at least one of the first layer and the second layer, and reallocate at least one of the at least one third CPU core to perform tasks corresponding to the first layer of the network environment based on the at least one network usage parameter.

The at least one network usage parameter may include at least one of a number of RRC users connected to the network environment and a number of PRBs to be processed in the network environment.

The at least one processor may be further configured to reallocate at least one of the at least one third CPU core to perform tasks corresponding to the first layer of the network environment by determining whether the number of RRC users is below an RRC user threshold and based on determining that the number of RRC users is below the RRC user threshold, reallocating the at least one third CPU core to perform tasks corresponding to the first layer of the network environment.

The at least one processor may be further configured to, after reallocating the at least one of the at least one third CPU core to perform tasks corresponding to the first layer of the network environment, determine whether the number of RRC users is above the RRC user threshold and based on determining that the number of RRC users is above the RRC user threshold, reallocating the at least one third CPU core to perform tasks corresponding to the second layer of the network environment.

The at least one third CPU core may include a first floating CPU core and a second floating CPU core allocated to perform tasks corresponding to the second layer of the network environment.

The at least one processor may be further configured to reallocate the at least one of the at least one third CPU core to perform tasks corresponding to the first layer of the network environment by determining whether the at least one network usage parameter is below a first network usage threshold and reallocating the first floating CPU core to perform tasks corresponding to the first layer of the network environment based on the at least one network usage parameter being below the first network usage threshold.

The at least one processor may be further configured to reallocate the at least one of the at least one third CPU core to perform tasks corresponding to the first layer of the network environment by determining whether the at least one network usage parameter is below a second network usage threshold and reallocating the first floating CPU core and the second floating CPU core to perform tasks corresponding to the first layer of the network environment based on the at least one network usage parameter being below the second network usage threshold.

The at least one network usage parameter may include a number of RRC users connected to the network environment, where the first network usage threshold is determined based on a first amount of RRC connected users, where the second network usage threshold is determined based a second amount of RRC connected users, and where the second amount of RRC connected users is less than the first amount of RRC connected users.

The first layer may be a physical layer of the network environment and the second layer may be a data link/scheduling layer of the network environment.

According to embodiments, a method for resource management in a network environment may include allocating at least one first CPU core to perform tasks corresponding to a first layer of the network environment, allocating at least one second CPU core to perform tasks corresponding to a second layer of the network environment, allocating at least one third CPU core to perform tasks corresponding to the second layer of the network environment, determining at least one network usage parameter corresponding to usage of at least one of the first layer and the second layer, and reallocating at least one of the at least one third CPU core to perform tasks corresponding to the first layer of the network environment based on the at least one network usage parameter.

The at least one network usage parameter may include at least one of a number of RRC users connected to the network environment and a number of PRBs to be processed in the network environment.

Reallocating the at least one of the at least one third CPU core to perform tasks corresponding to the first layer of the network environment may include determining whether the number of RRC users is below an RRC user threshold and based on determining that the number of RRC users is below the RRC user threshold, reallocating the at least one third CPU core to perform tasks corresponding to the first layer of the network environment.

After reallocating the at least one of the at least one third CPU core to perform tasks corresponding to the first layer of the network environment, the method may include determining whether the number of RRC users is above the RRC user threshold and based on determining that the number of RRC users is above the RRC user threshold, reallocating the at least one third CPU core to perform tasks corresponding to the second layer of the network environment.

The at least one third CPU core may include a first floating CPU core and a second floating CPU core allocated to perform tasks corresponding to the second layer of the network environment.

Reallocating the at least one of the at least one third CPU core to perform tasks corresponding to the first layer of the network environment may include determining whether the at least one network usage parameter is below a first network usage threshold and reallocating the first floating CPU core to perform tasks corresponding to the first layer of the network environment based on the at least one network usage parameter being below the first network usage threshold.

Reallocating the at least one of the at least one third CPU core to perform tasks corresponding to the first layer of the network environment may include determining whether the at least one network usage parameter is below a second network usage threshold and reallocating the first floating CPU core and the second floating CPU core to perform tasks corresponding to the first layer of the network environment based on the at least one network usage parameter being below the second network usage threshold.

The at least one network usage parameter may include a number of radio RRC users connected to the network environment, where the first network usage threshold is determined based on a first amount of RRC connected users, where the second network usage threshold is determined based a second amount of RRC connected users and where the second amount of RRC connected users is less than the first amount of RRC connected users.

The first layer may be a physical layer of the network environment and the second layer may be a data link/scheduling layer of the network environment.

According to embodiments, a non-transitory computer-readable storage medium may store instructions that, when executed by at least one processor, cause the at least one processor to allocate at least one first CPU core to perform tasks corresponding to a first layer of the network environment, allocate at least one second CPU core to perform tasks corresponding to a second layer of the network environment, allocate at least one third CPU core to perform tasks corresponding to the second layer of the network environment, determine at least one network usage parameter corresponding to usage of at least one of the first layer and the second layer, and reallocate at least one of the at least one third CPU core to perform tasks corresponding to the first layer of the network environment based on the at least one network usage parameter.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. An apparatus for resource management in a network environment, the apparatus comprising:
at least one memory storing instructions; and
at least one processor configured to execute the instructions to:
allocate at least one first central processing unit (CPU) core to perform tasks corresponding to a first layer of the network environment;
allocate at least one second CPU core to perform tasks corresponding to a second layer of the network environment;
allocate at least one third CPU core to perform tasks corresponding to the second layer of the network environment;
determine at least one network usage parameter corresponding to usage of at least one of the first layer and the second layer; and
reallocate at least one of the at least one third CPU core to perform tasks corresponding to the first layer of the network environment based on the at least one network usage parameter.

2. The apparatus of claim 1, wherein the at least one network usage parameter comprises at least one of:
a number of radio resource control (RRC) users connected to the network environment, and
a number of physical resource blocks (PRB s) to be processed in the network environment.

3. The apparatus of claim 2, wherein the at least one processor is further configured to reallocate at least one of the at least one third CPU core to perform tasks corresponding to the first layer of the network environment by:
determining whether the number of RRC users is below an RRC user threshold; and
based on determining that the number of RRC users is below the RRC user threshold, reallocating the at least one third CPU core to perform tasks corresponding to the first layer of the network environment.

4. The apparatus of claim 3, wherein the at least one processor is further configured to, after reallocating the at least one of the at least one third CPU core to perform tasks corresponding to the first layer of the network environment:
determine whether the number of RRC users is above the RRC user threshold; and
based on determining that the number of RRC users is above the RRC user threshold, reallocating the at least one third CPU core to perform tasks corresponding to the second layer of the network environment.

5. The apparatus of claim 1, wherein the at least one third CPU core comprises a first floating CPU core and a second floating CPU core allocated to perform tasks corresponding to the second layer of the network environment.

6. The apparatus of claim 5, wherein the at least one processor is further configured to reallocate the at least one of the at least one third CPU core to perform tasks corresponding to the first layer of the network environment by:
determining whether the at least one network usage parameter is below a first network usage threshold; and
reallocating the first floating CPU core to perform tasks corresponding to the first layer of the network environment based on the at least one network usage parameter being below the first network usage threshold.

7. The apparatus of claim 6, wherein the at least one processor is further configured to reallocate the at least one of the at least one third CPU core to perform tasks corresponding to the first layer of the network environment by:
determining whether the at least one network usage parameter is below a second network usage threshold; and
reallocating the first floating CPU core and the second floating CPU core to perform tasks corresponding to the first layer of the network environment based on the at least one network usage parameter being below the second network usage threshold.

8. The apparatus of claim 7, wherein the at least one network usage parameter comprises a number of radio resource control (RRC) users connected to the network environment,
wherein the first network usage threshold is determined based on a first amount of RRC connected users,
wherein the second network usage threshold is determined based a second amount of RRC connected users, and
wherein the second amount of RRC connected users is less than the first amount of RRC connected users.

9. The apparatus of claim 1, wherein the first layer is a physical layer of the network environment, and
wherein the second layer is a data link/scheduling layer of the network environment.

10. The apparatus of claim 1, wherein the first layer is a data link/scheduling layer of the network environment, and
wherein the second layer is a physical layer of the network environment.

11. A method for resource management in a network environment, the method comprising:
allocating at least one first central processing unit (CPU) core to perform tasks corresponding to a first layer of the network environment;
allocating at least one second CPU core to perform tasks corresponding to a second layer of the network environment;
allocating at least one third CPU core to perform tasks corresponding to the second layer of the network environment;
determining at least one network usage parameter corresponding to usage of at least one of the first layer and the second layer; and
reallocating at least one of the at least one third CPU core to perform tasks corresponding to the first layer of the network environment based on the at least one network usage parameter.

12. The method of claim 11, wherein the at least one network usage parameter comprises at least one of:
a number of radio resource control (RRC) users connected to the network environment, and
a number of physical resource blocks (PRB s) to be processed in the network environment.

13. The method of claim 12, wherein reallocating the at least one of the at least one third CPU core to perform tasks corresponding to the first layer of the network environment comprises:
determining whether the number of RRC users is below an RRC user threshold; and
based on determining that the number of RRC users is below the RRC user threshold, reallocating the at least one third CPU core to perform tasks corresponding to the first layer of the network environment.

14. The method of claim 13, wherein, after reallocating the at least one of the at least one third CPU core to perform tasks corresponding to the first layer of the network environment, the method further comprises:
determining whether the number of RRC users is above the RRC user threshold; and
based on determining that the number of RRC users is above the RRC user threshold, reallocating the at least one third CPU core to perform tasks corresponding to the second layer of the network environment.

15. The method of claim 11, wherein the at least one third CPU core comprises a first floating CPU core and a second floating CPU core allocated to perform tasks corresponding to the second layer of the network environment.

16. The method of claim 15, wherein reallocating the at least one of the at least one third CPU core to perform tasks corresponding to the first layer of the network environment comprises:
determining whether the at least one network usage parameter is below a first network usage threshold; and
reallocating the first floating CPU core to perform tasks corresponding to the first layer of the network environment based on the at least one network usage parameter being below the first network usage threshold.

17. The method of claim 16, wherein reallocating the at least one of the at least one third CPU core to perform tasks corresponding to the first layer of the network environment further comprises:
determining whether the at least one network usage parameter is below a second network usage threshold; and
reallocating the first floating CPU core and the second floating CPU core to perform tasks corresponding to the first layer of the network environment based on the at least one network usage parameter being below the second network usage threshold.

18. The method of claim 17, wherein the at least one network usage parameter comprises a number of radio resource control (RRC) users connected to the network environment,
wherein the first network usage threshold is determined based on a first amount of RRC connected users,
wherein the second network usage threshold is determined based a second amount of RRC connected users, and
wherein the second amount of RRC connected users is less than the first amount of RRC connected users.

19. The method of claim 11, wherein the first layer is a physical layer of the network environment, and
wherein the second layer is a data link/scheduling layer of the network environment.

20. A non-transitory computer-readable storage medium storing instructions that, when executed by at least one processor, cause the at least one processor to:
allocate at least one first central processing unit (CPU) core to perform tasks corresponding to a first layer of a network environment;
allocate at least one second CPU core to perform tasks corresponding to a second layer of the network environment;
allocate at least one third CPU core to perform tasks corresponding to the second layer of the network environment;
determine at least one network usage parameter corresponding to usage of at least one of the first layer and the second layer; and
reallocate at least one of the at least one third CPU core to perform tasks corresponding to the first layer of the network environment based on the at least one network usage parameter.
